(19) United States
(12) Patent Application Publication
(10) Pub. No.: US 2006/0176624 A1
(43) Pub. Date: Aug. 10, 2006

(54) Electronic circuit

(75) Inventors: Tadahiro Kuroda, Yokohama (JP); Daisuke Mizoguchi, Yokohama (JP); Noriyuki Miura, Yokohama (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: KEIO UNIVERSITY, Tokyo (JP)

(21) Appl. No.: 11/302,502

(22) Filed: Dec. 14, 2005

(30) Foreign Application Priority Data
Dec. 16, 2004 (JP) 2004-365151

(51) Int. Cl. H02H 7/04

(52) U.S. Cl. 361/38

(57) ABSTRACT

Where communications between substrates are formed by inductive coupling, the invention provides an electronic circuit that is less influenced by magnetic fluxes from a noise source. In the electronic circuit according to the invention, in regard to the transmitter coils and the receiver coils, one coil thereof is composed of the first coil 11a and the second coil 11b. The first coil 11a and the second coil 11b are wound by the same number of times and are connected to each other in series. When a current flows in the arrow direction, if observed so as to face the paper surface of the drawing, the second coil 11b is wound in the left direction while the first coil 11a is wound in the right direction. Where the first coil 11a and the second coil 11b are used as a receiver coil, since it is assumed that magnetic fluxes from a normal noise source enter the first coil 11 and the second coil 11b at the same intensity in the same direction, the magnetic fluxes are canceled each other out by the first coil 11a and the second coil 11b, which are wound reversely to each other, wherein no electromotive force is generated.

### BACKGROUND OF THE INVENTION

1. Field of the Invention

The present invention relates to an electronic circuit that is capable of suitably carrying out communications between substrates such as IC (Integrated Circuit) bare chips, and PCB (Printed Circuit Boards).

2. Description of the Related Art

The inventor et al. have proposed to achieve a system-in-package (SiP) for sealing a plurality of bare chips in one package of LSI (Large-Scale Integration) by a method for three-dimensionally mounting chips and electrically connecting chips to each other by inductive coupling (see Patent Document 1).

FIG. 2 is a view depicting a configuration of an electronic circuit according to the invention in Japanese earlier application. The electronic circuit is composed of the first through the third LSI chips 31a through 31c. This is an example in which LSI chips are stacked up in three layers and a bus is formed so as to lie across three chips. That is, a single communication channel capable of carrying out communications among the three (three LSI chips) is constructed. The first LSI chip 31a through the third LSI chip 31c are vertically stacked up, and the respective chips are fixed to each other with an adhesive agent. The first transmitter coil 33a through the third transmitter coil 33c, which are respectively used for transmission, are formed by wiring on the first LSI chip 31a through the third LSI chip 31c, and also, the first receiver coil 35a through the third receiver coil 35c, which are respectively used for receiving, are formed by wiring thereon. The three pairs of transmitter and receiver coils 33 and 35 are disposed on the first LSI chip 31a through the third LSI chip 31c so that the centers of openings of the transmitter and receiver coils 33 and 35 are made coincident with each other. Accordingly, the three pairs of transmitter and receiver coils 33 and 35 form inductive coupling, thereby enabling communications. The first transmitter circuit 32a through the third transmitter circuit 32c are connected to the first transmitter coil 33a through the third transmitter coil 33c, respectively, and the first receiver circuit 34a through the third receiver circuit 34c are connected to the first receiver coil 35a through the third receiver coil 35c, respectively. The transmitter and receiver coils 33 and 35 are three-dimensionally mounted as coils having one or more windings in an area permitted for communications, utilizing a multi-layered wiring of a process technology. A profile best suitable for communications exists in the transmitter and receiver coils 33 and 35, and it is necessary that they have an optimal number of times of winding, optimal opening, and optimal line width. Generally, the transmitter coils 33 are smaller than the receiver coils 35.

[Patent Document 1] Japanese Unexamined Patent Application Publication No. 2005-228981

### SUMMARY OF THE INVENTION

### PROBLEM TO BE SOLVED BY THE INVENTION

Herein, where a communications channel is constructed by inductive coupling between such a transmitter coil and a receiver coil, the communications channel is subjected to influences due to a magnetic flux from a noise source, and also is subjected to influences due to a leakage magnetic flux from an adjacent channel where such communications channels are disposed in parallel.

The present invention was developed in view of the above-described situations, and it is therefore an object of the invention to provide an electronic circuit which is hardly influenced by a magnetic flux from a noise source.

### MEANS FOR SOLVING THE PROBLEM

An electronic circuit according to the invention includes: a first substrate having a first coil wound and formed in the first direction by wiring on a substrate and a second coil connected to the first coil, wound and formed in the second direction, which is the reverse direction of the first direction; and a second substrate having a third coil wound and formed in the first direction at the position corresponding to the first coil by wiring on a substrate and inductively coupled to the first coil, and a first coil connected to the second coil, wound and formed in the second direction at the position corresponding to the second coil and inductively coupled to the second coil.

In addition, since both connection between the first coil and the second coil and connection between the third coil and the fourth coil are carried out in series, currents flowing in two coils which are connected in series can be made completely equal to each other, wherein it is possible to make equal the intensities of magnetic fluxes emitting from these two coils even if the production accuracy of the coils is more or less unsatisfactory.

Further, the first coil through the fourth coils are, respectively, composed of a plurality of coils, wherein a plurality of the first coils and the second coils are connected to each other and a plurality of the third coils and the fourth coils are connected to each other. Since a plurality of the third coils and the fourth coils are, respectively, formed at positions corresponding to each of the plurality of the third coils and the fourth coils, any magnetic flux coming from any direction (forward, backward, left and right) can be canceled out, thereby suppressing noise.

### EFFECT OF THE INVENTION

According to the invention, where communications between substrates are realized by inductive coupling, it is possible to cancel out an electromotive force based on a magnetic flux caused by a normal noise source, which is assumed to enter two coils, which becomes a pair, at the same intensity in the same direction, and possible to suppress noise. Also, to the contrary, an electronic circuit according to the invention has less influence on the periphery as a noise source. That is, since magnetic fluxes coming from two coils, which are transmitter coils and become a pair, are emitted in the reverse directions, a majority of the magnetic fluxes are closed in the vicinity of these coils and have less influence exerted further away.

The present specification includes the contents described in the specification and/or the drawings of Japanese Patent Application No. 2004-365151 which is the foundation of priority of the present application.

### BRIEF DESCRIPTION OF THE DRAWINGS

FIG. 1A and FIG. 1B are views depicting the construction of a transmitter coil and a receiver coil, which are used for an electronic circuit according to the example of the invention;

FIG. 2 is a view depicting the configuration of an electronic circuit according to the invention in Japanese earlier application.

### DETAILED DESCRIPTION OF THE INVENTION

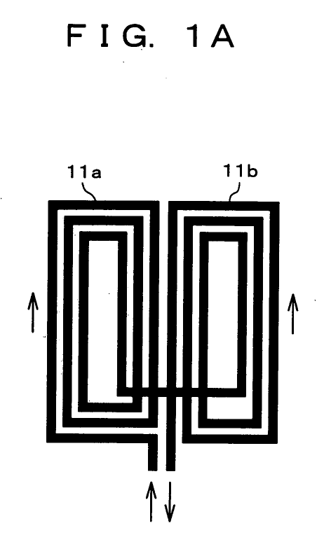

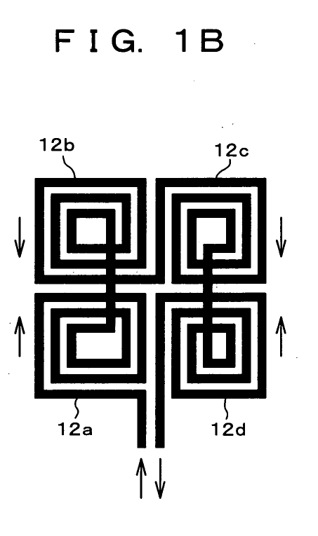

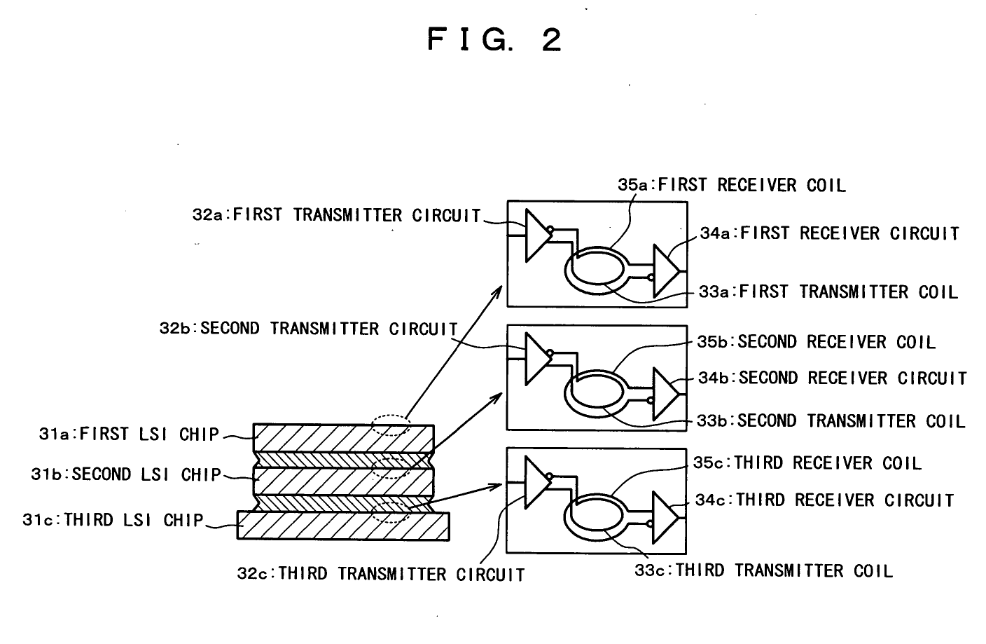

Hereinafter, a detailed description is given of a preferred embodiment for carrying out the invention with reference to the accompanying drawings. FIG. 1A and FIG. 1B are views depicting the construction of a transmitter coil and a receiver coil, which are used for an electronic circuit according to the example of the invention.

### EXAMPLE 1

FIG. 1A is a view depicting the construction of a transmitter coil and a receiver coil, which are used for an electronic circuit according to Example 1 of the invention. A transmitter coil and a receiver coil according to the example are such that one coil is composed of the first coil-11a and the second coil 11b. The first coil 11a and the second coil 11b are wound by the same number of times, and are connected to each other in series. When a current flows in the arrow direction, if observed so as to face the paper surface of the drawing, the second coil 11b is wound in the left direction while the first coil 11a is wound in the right direction. Therefore, if a current flows where it is assumed that the first coil 11a and the second coil 11b are transmitter coils, magnetic fluxes are emitted from the first coil 11a and the second coil 11b in the directions reverse to each other at the same intensity. Further, if magnetic fluxes in reverse directions to each other enter the first coil 11a and the second coil 11b where it is assumed that these coils are receiver coils, electromotive forces generated in the first coil 11a and the second coil 11b are added to each other to cause an electromotive force as a whole. Accordingly, one communications channel can be constructed by inductively coupling the transmission side and the receiving side using a set of the first coil 11a and the second coil 11b as a transmitter coil and a receiver coil, respectively.

Where the first coil 11a and the second coil 11b are used as the receiver coils, since it is assumed that magnetic fluxes from a normal noise source come in the first coil 11a and the second coil 11b at the same intensity in the same direction, the magnetic fluxes are canceled each other out by the first coil 11a and the second coil 11b, which are wound in reverse directions to each other, wherein no electromotive force is generated.

Thus, if a set of the first coil 11a and the second coil 11b according to the example is used as a transmitter coil and a receiver coil, respectively, although, in the receiver coil, an electromotive force is generated by magnetic fluxes from the transmitter coil that composes a communications channel by inductive coupling, it is possible to suppress the electromotive force due to magnetic fluxes emitted from a noise source. In addition, since magnetic fluxes from two transmitter coils that become a set are emitted in reverse directions, a majority of the magnetic fluxes are closed in the vicinity of these transmitter coils, and have less influence exerted further away from the position where the receiver coil exists.

### EXAMPLE 2

FIG. 1B is a view depicting the construction of a transmitter coil and a receiver coil, which are used for an electronic coil according to Example 2 of the invention. In regard to the transmitter coil and the receiver coil according to the Example, one coil is composed of four coils of the 11th coil 12a through the 14th coil 12d. The 11th coil through the 14th coil are wound by almost the same number of times and are connected to each other in series. When a current flows in the arrow direction, if observed so as to face the paper surface of the drawing, the 12th coil 12b and the 14th coil 12d are wound in the left direction while the 11th coil 12a and the 13th coil 12c are wound in the right direction. Therefore, if a current flows where it is assumed that the 11th coil 12a through the 14th coil 12d are transmitter coils, the magnetic fluxes emitted from the 11th coil 12a and the 13th coil 12c and the magnetic fluxes emitted from the 12th coil 12b and the 14th coil 12d are in the directions reverse to each other but have the same intensity. Further, where the 11th coil 12a through the 14th coil 12d are receiver coils, if magnetic fluxes in the direction reverse to each other are caused to enter the 11th coil 12a and the 13th coil 12c, and the 12th coil 12b and the 14th coil 14d, electromotive forces generated in the 11th coil 12a through the 14th coil 12d are added to each other, and electromotive forces are generated as a whole. Therefore, the respective sets of the 11th coil 12a through the 14th coil 12d are used as transmitter coils and receiver coils, respectively, and the transmission side and the receiving side are inductively coupled to each other, wherein it is possible to construct a single communication channel.

Where the 11th coil 12a through the 14th coil 12d are used as receiver coils, since it is assumed that magnetic fluxes from a normal noise source enter the 11th coil 12a through the 14th coil 12d at the same intensity in the same direction, the magnetic fluxes are canceled each other out by the 11th coil 12a and the 13th coil 12c, and the 12th coil 12b and the 14th coil 12d, which are reversely wound, respectively, wherein no electromotive force is generated. In the case of Example 1, in regard to magnetic fluxes entering from the direction along which two coils are disposed in parallel, the electromotive force of a nearer coil is made greater than that of the other, wherein the noise cannot be completely canceled out. However, in Example 2, since the coils are divided into four in the forward and backward, and left and right directions, it is possible to cancel out noise entering from any direction (forward, backward, left and right).

Thus, where sets of the 11th coil 12a through the 14th coil 12d are used as transmitter coils and receiver coils, respectively, although an electromotive force is generated for the magnetic flux from the transmitter coil that composes a communications channel by inductive coupling, it is possible to suppress the electromotive force based on the magnetic flux from the noise source. Further, the magnetic fluxes from four transmitter coils that become sets are emitted two by two in the directions reverse to each other, a majority of the magnetic fluxes are closed in the vicinity of the transmitter coils and have less influence exerted further away from the position where the receiver coils exist.

In addition, the invention is not limited to the above-described example.

In example 1, where a plurality of channels are disposed in parallel, since leakage magnetic fluxes from the adjacent channel are caused to enter a pair of coils at the same intensity in the same direction if rows of coils of an adjacent channel are made orthogonal to each other, almost all crosstalk with the adjacent channel can be eliminated.

In the examples, coils which are wound three times are depicted. However, the number of windings does not constitute any problem.

In the examples, the transmitter coil and the receiver coil are depicted as examples. However, as depicted as in the related arts (Japanese earlier application), for example, the transmitter coil is disposed inwardly, and the receiver coil is disposed outwardly, and the transmitter coil and the receiver coil may be disposed at the same position.

In the examples, an example in which the first coil and the second coil are connected in series is depicted. However, such an example in which these coils are connected in parallel may be employed. In the case of series connection, since currents flowing in two coils principally become equal to each other, it is possible to make equal the intensities of magnetic fluxes emitted from the two coils even if the production accuracy of the coils is more or less unsatisfactory.

All the publications, patents and patent applications cited in the present specification are included, as they are, as references.

What is claimed is:

1. An electronic circuit including:
a first substrate having a first coil wound and formed in the first direction by wiring on a substrate and a second coil connected to said first coil, wound and formed in the second direction, which is the reverse direction of the first direction; and
a second substrate having a third coil wound and formed in the first direction at the position corresponding to said first coil by wiring on a substrate and inductively coupled to said first coil, and a fourth coil connected to said third coil, wound and formed in the second direction at the position corresponding to said second coil and inductively coupled to said second coil.

2. The electronic circuit according to claim 1, wherein both connection of said first coil to said second coil and connection of said third coil to said fourth coil are carried out in series.

3. The electronic circuit according to claim 1, wherein said first coil through said fourth coil are composed of a plurality of coils, a plurality of said first coils and said second coils are connected to each other, a plurality of said third coils and said fourth coils are also connected to each other, and the plurality of said third coils and said fourth coils are, respectively, formed at positions corresponding to the plurality of said first coils and said second coils.
